(19) United States
(12) Patent Application Publication
(10) Pub. No.: US 2002/0057676 A1
(43) Pub. Date: May 16, 2002

(54) Method and system for communicating ISDN over ATM-based next generation access networks using primary rate interface

(76) Inventors: Beni Cohen-Adiv, Ra'anana (IL); Alexander Agranovsky, Friedrichsdorf (DE); Liat Cides-Grozouik, Tel-Aviv (IL)

Correspondence Address: Edward Langer, Pat. Atty., c/o Landon & Stark Associates, One Crystal Park, Suite 210, 2011 Crystal Drive, Arlington, VA, 22202, US

(21) Appl. No.: 09/983,765

(22) Filed: Oct. 25, 2001

Related U.S. Application Data
(60) Provisional application No. 60/243,534, filed on Oct. 26, 2000.

(51) Int. Cl. H04L 12/66

(52) U.S. Cl. 370/352; 370/395.1

(57) ABSTRACT

A system is disclosed to provide a voice gateway to deliver voice over Asynchronous Transfer Mode (VoATM) via an electronic network for digital data signals, by transferring and converting voice streams from a Public Switched Telephone Network (PSTN), via at least one local exchange, for transmission at a constant bit rate and encapsulates voice data on ATM cells for delivery to customer premises equipment (CPE), such as at least one Primary Rate Interface (PRI) port, said system including a voice gateway to deliver the VoATM, a central office-based inter-working function (CO-IWF) that interfaces said CPE directly to said electronic network, said CO-IWF having a port control protocol for transferring activation/deactivation indications or requests over said CPE to CO-IWF interface and a customer premises inter-working function (CP-IWF) that serves as a gateway between said digital data signals used in said electronic network and said PSTN.

### FIELD OF THE INVENTION

The present invention relates generally to telecommunications, and in particular, the invention relates to the communication of voice and Integrated Systems Digital Networks (ISDN) Primary Rate Interface (PRI), over broadband Next Generation Access (NGA) networks between the customer premises of larger users and the Public Switch Telephone Network (PSTN).

Papers referenced are listed at the end of the specification.

### BACKGROUND OF THE INVENTION

The following trends represent a driving force towards dramatic change in the global telecommunications industry: (1) deregulation; and (2) increased competition and consolidation.

For more than 100 years the telecommunications industry has been heavily regulated. Incumbent service providers, such as the regional Bell operating companies in the United States and state-owned telecommunications monopolies in European countries, enjoyed a protected monopoly in several sectors of the industry, including voice services. However, the Telecommunications Act of 1996 in the United States, a series of European Union directives in Europe and international agreements such as the World Trade Organization agreement of 1997, have resulted in deregulation of the telecommunications industry. Deregulation has created competition between the former monopolistic, incumbent service providers, and new or emerging service providers such as Competitive Local Exchange Carriers (CLECs), cable television (TV) operators, Internet service providers and satellite communications companies. Thus, as a result of deregulation, and increased competition and consolidation, these service providers are competing for all telecommunications services, including voice, video and data. For example, cable TV operators are now offering voice services in addition to cable TV services.

Most recently, regulators have focused on promoting competition in the segment connecting customers to service providers' central offices, also referred to as the local loop or the access network. In many countries, regulators are encouraging, and in some cases requiring, incumbent service providers to separate voice services from the other services they provide, also known as unbundling, to allow customers to choose separate service providers for different services.

These regulators are also encouraging or requiring incumbent service providers to allow emerging service providers to locate their equipment at the incumbent service providers' central offices, also known as co-location. Additionally, increased competition has led to consolidation within the telecommunications industry, as service providers seek to broaden their service offerings and geographic reach, reduce costs and differentiate themselves from their competitors.

Deregulation, increased competition and growth in data traffic are causing significant changes in the architecture of telecommunications networks. A telecommunications network can generally be divided into voice and data backbones, central offices, access networks and customer-premises equipment (CPE), such as telephones, fax machines and computers.

The PSTN-voice backbone and data backbone networks comprise high bandwidth fiber optic links, switches, routers and transmission equipment. Service providers have made, and are continuing to make, significant investments in backbone networks to increase the capacity and bandwidth of existing networks and to create new networks.

Traditionally, two separate backbones carried voice and data traffic: public switched telephone networks carried voice and data networks carried data. Although some service providers are seeking to converge the two backbone networks into one backbone network capable of carrying both data and voice traffic, other service providers, particularly incumbent service providers, continue to invest and maintain separate voice and data backbones.

Central offices connect backbone networks and access networks. Central offices host voice switches that switch incoming and outgoing voice calls to their ultimate destination, and host routers and data switches that handle data traffic. Service providers using class 5 switches, a type of voice switch typically installed at central offices, offer their customers a variety of value-added services, such as call forwarding, call waiting and caller identification. Historically, incumbent service providers owned and operated central offices.

Access networks comprise access lines and equipment connecting service providers' central offices to CPE's and Integrated Access Devices (IAD's) /Media Terminal Adapters (MTAs), which connect several CPE's. The access equipment communicates with central office equipment using a variety of signaling systems, or protocols, which regulate the exchange of information between PSTN switches and access equipment. For example, V5.2 is a non-proprietary, open protocol that PSTN switches and access equipment use to communicate with one another, and is the standard protocol outside the United States and Canada. Other open protocols include GR-303, which is the new North American access protocol. The V5.2 standard specifies an open interface for access network systems. With concentration and protection features, the V5 standard was approved by the European Telecommunications Standards Institute (ETSI) and the International Telecommunications Union (ITU) and adopted by European, Asian, Australian and Latin America carriers for PSTN, integrated services digital networks (ISDN) and leased lines.

Bottenecks in networks occur where the capacity, or bandwidth, of a network segment is not sufficient to effectively handle the volume of telecommunications traffic. As a result of recent investments made to increase the capacity of backbone networks and accommodate the growth in data traffic, the bottleneck in the network has shifted to the access network, due to the bandwidth limitations of twisted pair copper wire access lines. Prior to the development of Next Generation Access (NGA) technologies, copper lines supported only low-bandwidth traffic such as analog voice or data transmissions with speeds up to 64 kilobits per second (kbps), for dial-up modems, and speeds of up to a maximum of 128 kbps for ISDN lines. To cost-effectively overcome the limitations of the existing copper lines, service providers have been deploying new technologies and access networks that enable them to deliver high-bandwidth, or broadband, communications services to their subscribers.

The access bottleneck can be addressed by NGA methods either by enhancing the bandwidth available on existing copper lines or by providing services over alternative access networks such as cable TV or broadband wireless networks, as illustrated in prior art FIG. 1a.

The following technologies address the bottleneck:

Digital Subscriber Lines (xDSL) is a generic name for a set of technologies, such as Digital Subscriber Line Access Multiplexer (DSLAM) 12, which is designed to increase bandwidth over existing copper lines using sophisticated digital signal processing techniques: specifically, a device which takes a number of ADSL subscriber lines and concentrates these to a single ATM line;

Cable TV Technologies comprise TV networks, having a Hybrid Fiber Coax (HFC) head-end 14, consisting of fiber optic cables and coaxial cables connected to the customers' premises, and were deployed by cable TV companies to carry one-way analog television. Cable data and telephone modem technologies have been developed to carry other types of transmissions, including voice or data, over the cable network, taking advantage of cables' superior bandwidth; and

Broadband Wireless Technologies connect subscribers to central offices through radio signals transmitted to and from fixed radio transmitters 16 installed at the customers' premises and at radio base stations. A base station aggregates voice and data transmissions from several subscribers, and transmits them to a central office.

Access networks based on xDSL, cable TV and broadband wireless technologies are referred to as NGA networks. NGA networks enable service providers to offer high-speed data services to small and medium-sized businesses as well as to residential subscribers. However, they were not designed to efficiently carry high-quality voice traffic.

The PSTN Access Gateway provides connectivity from the following NGA Equipment:

digital subscriber line access multiplexer (DSLAM) for copper infrastructure;

HFC Head-end for Cable infrastructure; and

Wireless Base Station for Wireless infrastructure or asynchronous transfer mode switch/Internet protocol (ATM/IP) router to the Class 5 PSTN switch.

The PSTN Access Gateway serves as the bridge between the circuit-based voice switch and the packet-based data network. It receives voice traffic in an IP packet format, converts to standard time division multiplexing (TDM) pulse-coded modulation PCM format and connects to the Class 5 PSTN switch via multiple E1/T1 interfaces. The PSTN Access Gateway can be located at the service provider's central office. For example, in the diagram, a subscriber initates a call through a telephone connected to an IAD/MTA.

The IAD/MTA will connect to the PSTN Access Gateway over the NGA network. The call, including the voice and all related information such as the call's destination, is carried over this connection. To connect between the PSTN switch and the IAD/MTA, the PSTN Access Gateway simultaneously converts the data protocols used by the IAD's/MTA's and NGA equipment such as IP, into the V5 protocol used by the voice switch, and vice versa.

VoATM (Voice over ATM) is a method of transporting voice streams over an Asynchronous Transfer Mode (ATM) infrastructure. ATM technology is based on transmitting fixed-size (53 bytes) cells at a very fast rate, enabling a large amount of traffic to be transmitted over the network backbone. ATM has significant inherent advantages, such as Quality of Service (QoS). Using the inherent features of QoS, ATM can guarantee voice streams required for high quality voice transmission. VoATM enables voice streams to be transmitted at a constant bit rate and encapsulates voice data on ATM cells. Two options are available for transferring voice over ATM: ATM Adaptation Layer 1 (AAL1) and ATM Adaptation Layer 2 (AAL2). AAL1 was the first method developed to transport voice over ATM and is used mainly to transport E1/T1 links over ATM. AAL 2 is a more recent development, which effectively enhances Voice over ATM transport for any voice rate. AAL2 is capable of transmitting both voice and data traffic, which provides means to transfer ISDN traffic comprising B-channel and D-channel traffic over the ATM networks.

In the Integrated Services Digital Network (ISDN), there are two levels of service: the Basic Rate Interface (BRI), intended for the home and small enterprise, and the Primary Rate Interface (PRI), for larger users. Both rates include a number of B-channels and a D-channel for BRI and a Bd-channel for PRI. Each B-channel carries data, voice, and other services. The D-channel or Bd-channel carries control and signaling information.

The BRI consists of two 64 Kbps B-channels and one 16 Kbps D-channel. Thus, a BRI user can have up to 128 Kbps service. The PRI consists of 23 B-channels and one 64 Kbps Bd-channel using a T-1 line or 30 B-channels and 1 Bd-channel using an E1 line. Thus, a PRI user on a T-1 line can have up to 1.544 Mbps service or up to 2.048 Mbps service on an E1 line. PRI uses the Q.931 protocol over the Bd-channel.

The PRI channels are carried on a T-carrier system line in the U.S., Canada, and Japan or an E-carrier line in other countries, and are typically used by medium to large enterprises. The 23 or 30 B-channels can be used flexibly and reassigned when necessary to meet special needs such as video conferences. The Primary Rate user is hooked up directly to the telephone company central office. Many analysts envision rapid expansion of video conferencing in the current climate of security consciousness prevalent in the spread of globalization. Large businesses have long been interested in video conferencing, but now medium-sized businesses are interested as well. Thus, the trend from small business implementation of BRI to medium and large business implementation of PRI is likely to accelerate.

Existing methods define the intercommunication functionality for ISDN BRI subscribers. Thus, there is a need for means of communicating ISDN PRI over ATM AAL2 that acts as a gateway between the PSTN/ISDN switch and customer premises.

### SUMMARY OF THE INVENTION

Accordingly, it is a principal object of the present invention to provide a system and method to communicating Primary Rate Interface (PRI) ISDN over ATM AAL2 that acts as a gateway between the PSTN/ISDN switch and larger customer premises.

It is a further object of the present invention to use the inherent features of QoS, to provide a PRI ATM interface that enables flexible allocation of voice streams that can better utilize high quality voice transmission.

It is another object of the present invention to provide a PSTN Access Gateway enabling more flexible connectivity from NGA Equipment that includes a full variety of service requirements, such as digital subscriber line access multiplexer (DSLAM) for copper infrastructure, HFC Head-end for Cable infrastructure and Wireless Base Station for Wireless infrastructure or asynchronous transfer mode switch/Internet protocol (ATM/IP) router to the Class 5 PSTN switch.

The invention is a simple and efficient method and system for communicating Primary Rate Interface (PRI) ISDN over Asynchronous Transfer Mode (ATM) infrastructure AAL2 that acts as a gateway between the PSTN/ISDN switch and customer premises. The method defines the interface between the PSTN/ISDN Access Gateway and the Integrated Access Device (IAD) comprising the Customer Premises Equipment (CPE), which supports the PRI Integrated Services Digital Network (ISDN) and the Public Switched Telephone Network (PSTN) Channel Associated Signaling (CAS) protocol. The method combines ATM standards and the customization of the ISDN Port Control protocol from the V5 standard to create an easily supportable PRI ISDN interface with port control channel activation support. Port control channel activation keeps track of the dynamic state of the ISDN ports, and synchronizes between network components. This feature ensures system reliability and increases the effective utilization of network resources.

A system is disclosed to provide a voice gateway to deliver voice over Asynchronous Transfer Mode (VoATM) via an electronic network for digital data signals, by transferring and converting voice streams from a Public Switched Telephone Network (PSTN), via at least one local exchange, for transmission at a constant bit rate and encapsulates voice data on ATM cells for delivery to customer premises equipment (CPE), such as at least one Primary Rate Interface (PRI) port, said system including a voice gateway to deliver the VoATM, a central office-based inter-working function (CO-IWF) that interfaces said CPE directly to said electronic network, said CO-IWF having a port control protocol for transferring activation/deactivation indications or requests over said CPE to CO-IWF interface and a customer premises inter-working function (CP-IWF) that serves as a gateway between said digital data signals used in said electronic network and said PSTN.

A method is described to provide interfacing of the network components, using the system as defined above, for a Public Switched Telephone Network /Integrated Services Digital Network (PSTN/ISDN) access gateway for Primary Rate Interface (PRI) ISDN over Asynchronous Transfer Mode (ATM) infrastructure Adaptation Layer 2 (AAL2) that acts as a gateway between the PSTN/ISDN switch and customer premises, providing both PSTN for a plurality of telephone calls and ISDN services for a plurality of users, said method including customizing the ISDN port control protocol from the V5 standard, combining ATM standards and said customized protocol, keeping track of the dynamic state of the ISDN ports, synchronizing between the network components, initiating activation of at least one of the plurality of telephone calls and initiating deactivation of said at least one of the plurality of telephone calls.

Other features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding elements or sections throughout, and in which:

FIG. 1a is a schematic illustration of a prior art telecommunications network, showing alternative access networks;

FIG. 1b is a schematic illustration of a prior art telecommunications network, showing a variety of customer premises equipment;

FIG. 2 is a prior art schematic block diagram of a subscriber initiating a telephone call through an integrated access device (IAD);

FIG. 3 is a schematic block diagram relating to a telephone call made by an ISDN PRI subscriber over the ATM, and interfaced to the TDM, in accordance with the principles of the present invention; and

FIG. 4 is a schematic block diagram of the inter-working function (IWF) connections for a PSTN switch and ATM network, in accordance with the principles of the present invention.

### DETAILED DESCRIPTION OF PREFERRED EMBODIMENTS

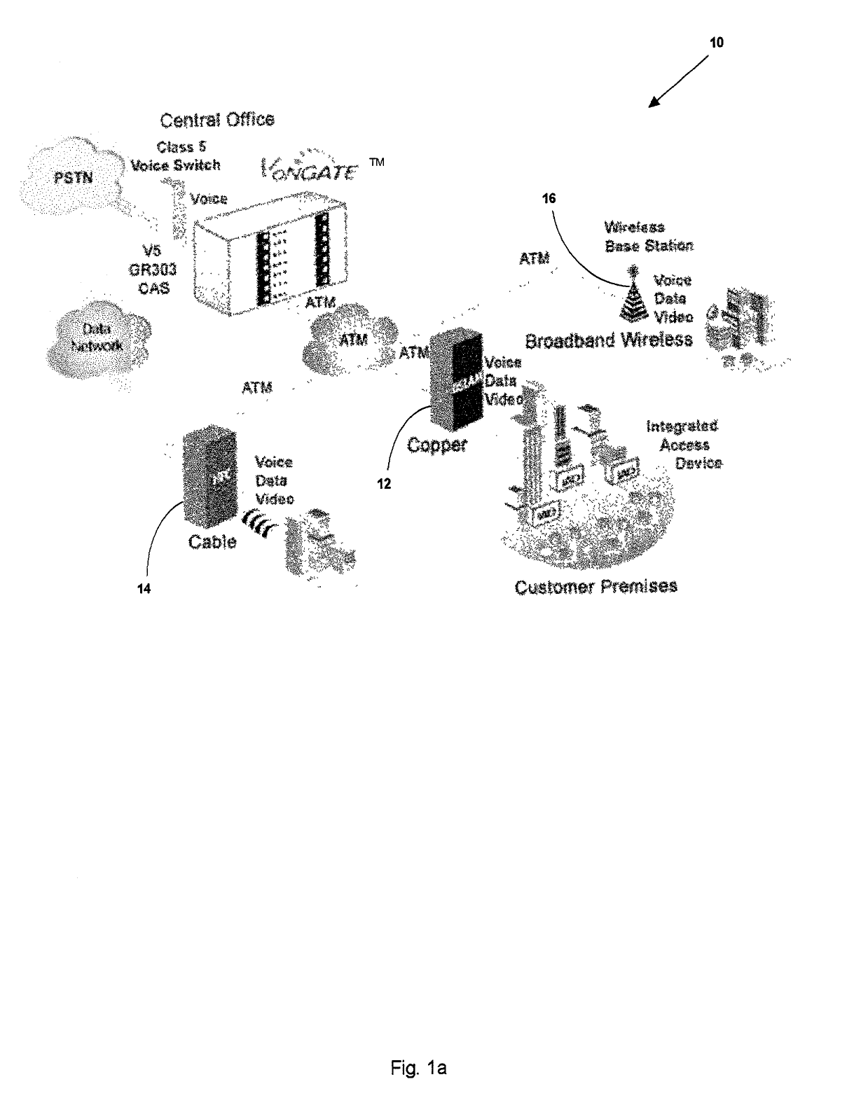

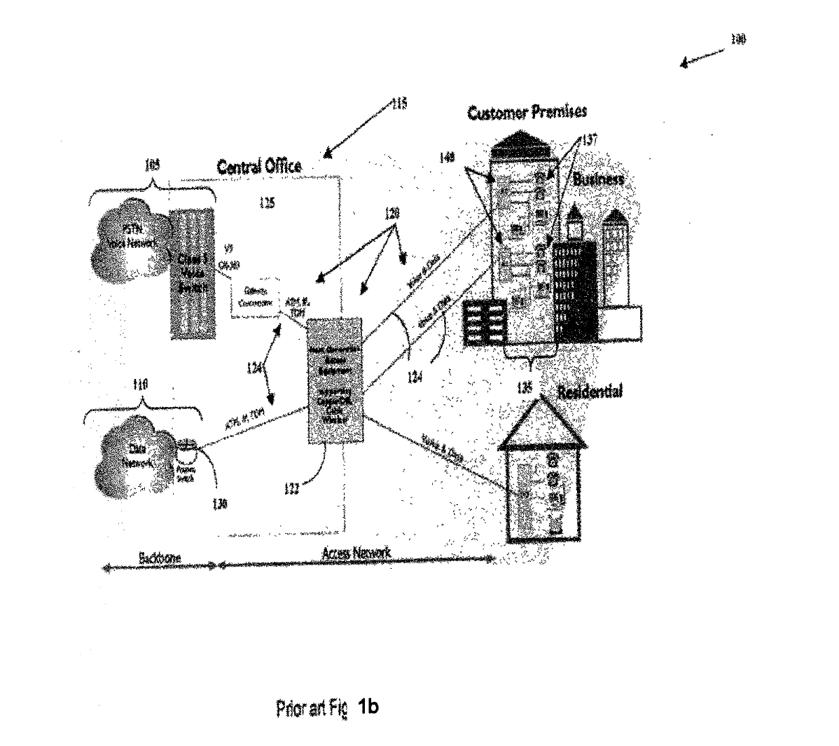

FIG. 1a is a schematic illustration of a prior art telecommunications network, showing alternative access networks, and is described hereinabove as background.

Reference is now made to FIG. 1b, which is a schematic illustration of prior art telecommunications network, showing a variety of customer premises equipment. Traditionally, two separate backbones carried voice and data traffic: a public switched telephone network (PSTN) backbone 105 carried voice and an IP packet-based data network 110 or backbone carried data. A central office 115 connects backbone networks 105 and 110 to an access network 120. Central office 115 hosts a voice switch 125 that switches incoming and outgoing voice calls to their ultimate destination, and hosts routers and data switches 130 that handle data traffic. Service providers using class 5 switches, a type of voice switch typically installed at central offices, offer their customers a variety of value-added services, such as call forwarding, call waiting and caller identification.

Access network 120 comprises access lines 124 and equipment 122 connecting service providers' central office 115 to customer premises equipment (CPE) 135 and Integrated Access Devices (IAD's) IMedia Terminal Adapters (MTAs) 140, which connect several CPE's 137.

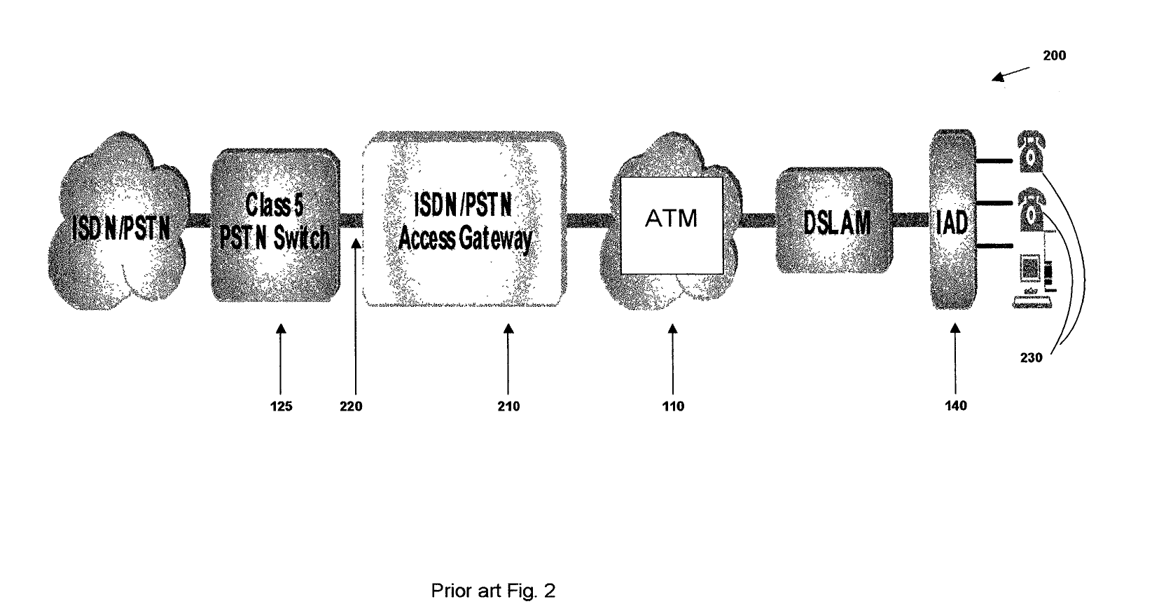

FIG. 2 is a prior art schematic block diagram of a subscriber initiating a telephone call through integrated access device (IAD) 140. The PSTN Access Gateway 220 serves as the bridge between the circuit-based voice switch, i.e. class 5 PSTN switch 125 and Asynchronous Transfer Mode (ATM) infrastructure 110. It receives voice traffic in ATM format, converts to standard time division multiplexing (TDM) pulse-coded modulation PCM format, and connects to Class 5 PSTN switch 125 via multiple E1/T1 interfaces 220.

PSTN Access Gateway 220 can be located at the service provider's central office. For example, in FIG. 2, a subscriber initiates a call through one of the telephones 230 connected to IAD/MTA 140.

IAD/MTA 140 connects to PSTN Access Gateway 220 over the NGA network. The call, including the voice and all related information such as the call's destination, is carried over this connection. To connect between the PSTN switch 125 and IAD/MTA 140, PSTN Access Gateway 210 simultaneously converts the data protocols used by IAD's/MTA's 140 and NGA equipment such as ATM 110, into the V5 protocol used by the voice switch 125, and vice versa.

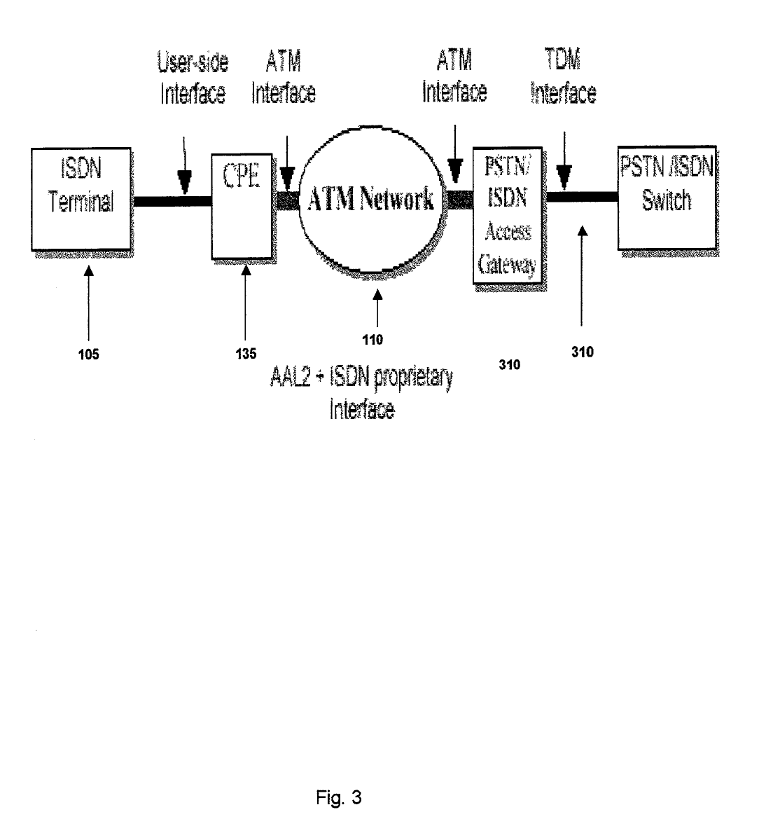

FIG. 3 is a schematic block diagram relating to a telephone call 300 made by an ISDN PRI subscriber over ATM network 110 and interfaced by TDM 310, in accordance with the principles of the present invention. Customer Premises Equipment (CPE) 135 is interfacing both PSTN/ISDN 105 and ATM network 110. ATM network 110 is a proprietary interface combining PRI ISDN AAL2 ATM.

The following figures and specifications illustrate and describe the interface for the Integrated Systems Digital Networks (ISDN) over ATM connection between the CPE device and the Central Office (CO-IWF) inter-working function. The CPE multiplexes several ISDN Primary Rate Interface (PRI) users into one or more ATM channels. The CO-IWF provides access for multiplexed ATM channels to the TDM world. All interfaces are based on IETF, International Telecommunications Union (ITU), European Telecommunications Standards Institute (ETSI) and asynchronous transfer mode (ATM) Forum standards, which are included by way of specific references hereinbelow.

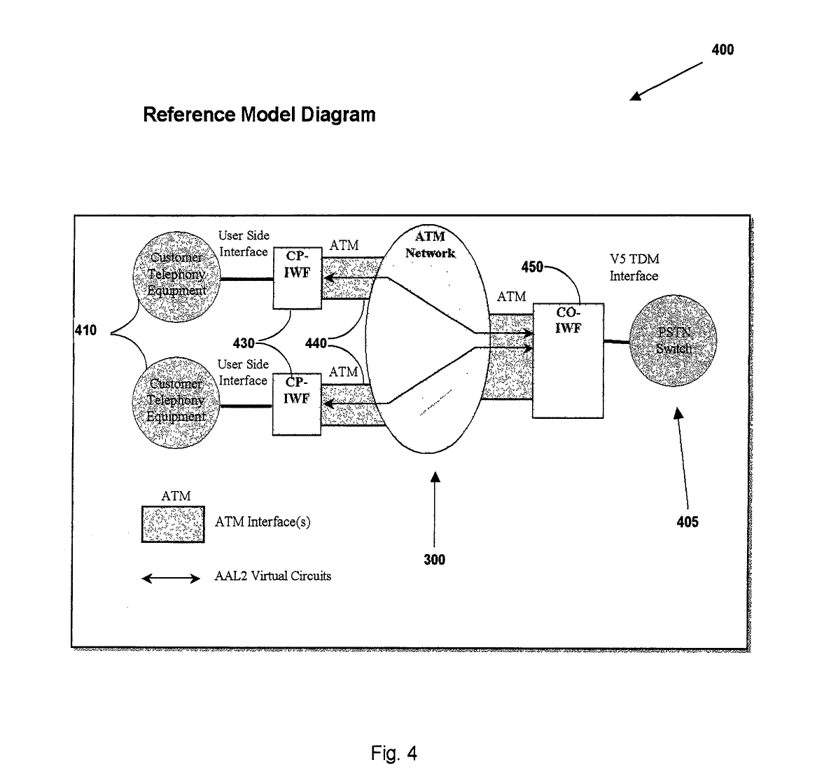

FIG. 4 is a schematic block diagram of the inter-working function (IWF) connections 400 for a PSTN switch 405 and ATM network 110, in accordance with the principles of the present invention. The customer telephony equipment 410 comprises PSTN/POTS modules, which can be a POTS/ISDN telephone, modem or fax machine.

The Customer Premises-Inter-Working Function (CP-IWF) 430 depends on the Next Generation Access (NGA) platform used, It can, for example, be a cable modem access box, i.e. a set-top box, interfacing the (1) TV set (2) PSTN/ISDN and (3) Data port on the user-side interface 430 side, and an ATM interface 440 on the other side.

CO-IWF 450 includes the Next Generation Access (NGA).

The CPE and CO-IWF components provide a complete solution for the “ISON over ATM” connection with the following system requirements:

From the user side, each CPE device should be capable of providing services for up to several ISDN PRI ports. The D-channel should be transmitted as raw data only, without the High-Level Data Link Control (HDLC) format.

The following issues should be taken into account when defining the interface between the CPE and CO-IWF devices:

Voice Transmission: Each ISDN PRI port contains up thirty (30) 64 Kbps bearer channels, which are managed by Q.921 Call Control messages transferred on the 64 Kbps Bd-channel. Voice channels should be transmitted on the ATM network according to 1.366.2 ITU-T specification (see reference 3);

Data Transmission: Q.921 Call Control messages are transferred on the 64 Kbps Bd-channel. Data channels should be transmitted according to 1.366.1 ITU-T specification; and

B-Channel Transmission Enable/Disable: The interface should transmit voice patterns on active connections only, thereby providing so-called “idle suppression”. The active state is determined by the Voice Gateway and transferred to the CPE using procedures similar to those described in af-vmoa-0145 (see reference 1).

For ISDN over AAL2: A single CPE device is assigned a single virtual path identfier/virtual channel identifier (VPI/VCI) pair. ATM's two-level labels—(VPI/VCI)—correspond to cable numbers (VPI) and wire pair numbers (VCI). VPI switches connect cable to cable, patching like-colored wires together, wherein only the cable number changes, while VCI switches are full-function patch panels, cross-connecting at the wire pair level:

B-Channel: Each B-channel of each ISDN PRI port is associated with a single AAL2 Channel Identifier (CID) within the AAL2 connection. The association is done dynamically according to procedures similar to those described in af-vmoa-0145 ATM Forum specification (see reference 1);

Bd-Channel: Each Bd-channel of each ISDN BRI port is associated with a single CID within the AAL2 connection and uses User-to-User Indication (UUI)=26-27 for Framed Mode data with Service Specific Segmentation and Reassembly (SSSAR) and Service Specific Transmission Error Detection (SSTED). The association is done dynamically according to the procedures similar to those described in af-vmoa-0145 ATM Forum specification. Q.921 Call Control messages are sent in an AAL2 encapsulation type. Each side (CPE/CO-IWF) should reassemble the received ATM cells into a Q.921 Call Control message and segment the transmitted Q.921 Call Control message into ATM cells; and

Emulated Loop Control Channel: The Emulated Loop Control Protocol (ELCP) is defined for ISDN PRI port management and AAL2 Channel allocation/de-allocation. The messages used for PRI ELCP are enhanced modifications of messages described in af-vmoa-0145 ATM Forum specification. (see reference 1). The ELCP messages are sent on CID 8 with UUI=26-27 using Framed Mode data with SSSAR and SSTED.

### REFERENCE DOCUMENTS

1. ATM Forum af-vmoa-0145, 2000, Voice and Multimedia Over ATM—Loop Emulation Service Using ML2

2. ITU-TI.363.2 (09/97) B-ISDN ATM Adaptation layer specification: Type 2 AAL.

3. ITU-TI.366.2 (02/99) ML Type 2 Service Specific Convergence Sub-layer For Trunking.

4. ATM Forum af-vtoa-0078.00 (01/97) Circuit Emulation Service Version 2.0

5. ATM Forum af-vtoa-0113.00 (02/99) ATM Trunking using AAL2 for Narrowband Services.

6. ATM Forum 99-0932 (07/99) Loop emulation service and new profile definition for voice over AAL2.

7. ETS 300-324.1 V5.1 specification

8. ETS 300-347.1 V5.2 specification

1. A system to provide a voice gateway to deliver voice over Asynchronous Transfer Mode (VoATM) via an electronic network for digital data signals, by transferring and converting voice streams from a Public Switched Telephone Network (PSTN), via at least one local exchange, for transmission at a constant bit rate, and encapsulating voice data on ATM cells for delivery to customer premises equipment (CPE), such as at least one Primary Rate Interface (PRI) port, said system comprising:
a voice gateway to deliver the VoATM;
a central office-based inter-working function (CO-IWF) that interfaces said CPE directly to said electronic network, said CO-IWF having a port control protocol for transferring activation/deactivation indications or requests over said CPE to CO-IWF interface; and
a customer premises inter-working function (CP-IWF) that serves as a gateway between said digital data signals used in said electronic network and said PSTN.

2. A system according to claim 1, wherein said voice gateway provides connectivity from a Hybrid Fiber Coax (HFC) head-end for cable infrastructure.

3. A system according to claim 1, wherein said voice gateway provides connectivity from a digital subscriber line access multiplexer for copper infrastructure.

4. A system according to claim 1, wherein said voice gateway provides connectivity from broadband wireless technologies for transmission of radio signals.

5. A method to provide interfacing of the network components, using the system as defined in claims 1, for a Public Switched Telephone Network /Integrated Services Digital Network (PSTN/ISDN) access gateway for Primary Rate Interface (PRI) ISDN over Asynchronous Transfer Mode (ATM) infrastructure Adaptation Layer 2 (AAL2) that acts as a gateway between the PSTN/ISDN switch and customer premises, providing both PSTN for a plurality of telephone calls and ISDN services for a plurality of users, said method comprising:
customizing the ISDN port control protocol from the V5 standard;
combining ATM standards and said customized protocol;
keeping track of the dynamic state of the ISDN ports;
synchronizing between the network components;
initiating activation of at least one of the plurality of telephone calls; and
initiating deactivation of said at least one of the plurality of telephone calls.

6. A method according to claim 5, wherein the interfacing supports the PSTN Channel Associated Signaling (CAS) protocol.
